(19) United States
(12) Patent Application Publication
(10) Pub. No.: US 2012/0069142 A1
(43) Pub. Date: Mar. 22, 2012

(54) PSEUDO-HOLOGRAPHIC REPRESENTATION

(76) Inventors: Gabriela Cochius, Diessen am Ammersee (DE); Bernhard Moser, Hargelsberg (AT)

(21) Appl. No.: 13/255,287

(22) PCT Filed: Mar. 10, 2010
(86) PCT No.: PCT/AT2010/000073

§ 371 Date: Nov. 16, 2011

(30) Foreign Application Priority Data
Mar. 10, 2009 (AT) A 385/2009

(51) Int. Cl. H04N 5/89

(52) U.S. Cl. 348/40

(57) ABSTRACT

A method for generating a pseudo holographic image (11) from a first original image (10) comprising a plurality of first pixels (3) and a second original image (10′) comprising a plurality of second pixels (3′), whereby first image analysis pixels (1) are selected from the plurality of first pixels (3) in a predetermined order, the method of the invention comprising the following steps for each selected image analysis pixel:
creating of a first variable, adaptive environment area (2) in the first original image (10) around a first analysis pixel (1),
searching for a second environment area in the second original image (10′), said second environment area (2′) correlating with the first environment area (2),
determining a second image analysis pixel (1′) in the second environment area (2′), said second image analysis pixel (1′) correlating with the first image analysis pixel (1).

A method for generating a pseudo holographic image from a first original image comprising a plurality of first pixels and a second original image comprising a plurality of second pixels, whereby first image analysis pixels are selected from the plurality of first pixels in a predetermined order.

As known in the prior art, pseudo holographic images are generated from at least two original images, whereby the first position at which the first original image is taken differs from further positions at which further original images are taken.

According to the prior art, said first image analysis pixels are selected from a plurality of first pixels line by line.

The dissertation of Mr. Lutz Falkenhagen (L. Falkenhagen, Blockbasierte Disparitätsabschätzung unter Berücksichtigung statistischer Abhängigkeiten der Disparitäten, VDI Verlag, Düsseldorf, Germany (2001)) is based on a method for analysing or processing rigidly defined environment areas around a plurality of image analysis pixels (block matching method), said analysis comprising the aspects of a multi-stage approach (simple block matching via correlation, hierarchical block matching, hierarchical block matching via correlation), the consideration of monotony conditions for disparities (dynamic programming), and the consideration of statistical dependencies. Statistical dependencies are used to distinguish hidden pixels from existing correspondence pixels. To assess the reliability of this approach, a so called cross comparison (comparison of the disparity estimations of the two directions of the image set-up) was computed.

The disparity estimation according to Falkenhagen does not always provide ideal results. Especially in connection with moving images, blurred areas are observed in the pseudo holographic image.

In the invention discussed herein, the problem of poor quality of the pseudo holographic image is solved by the method of the invention which comprises carrying out the following steps for each selected image analysis pixel:
creating a first variable, adaptive environment area in the first original image around a first analysis pixel,
searching a second environment area in the second original image, said second environment area correlating with the first environment area,
determining a second image analysis pixel in the second environment area, said second image analysis pixel correlating with the first image analysis pixel.

A first environment area, which can be varied and adapted depending on the first original image, is defined around the selected first image analysis pixel. The environment areas can be created by changing the forms of the existing environment areas and/or by creating new environment areas, based on the assignment of geometrical, partly overlapping forms, such as rectangles, whereby each of said forms contains an image analysis pixel.

The environment areas can be adapted by being scaled. The first environment area and/or the second environment area can, for example, be adapted to the image information of the first or the second original image, respectively, by methods, such as segmentation methods, which are analogous to the grid generation methods for calculations according to the finite element method.

In the second original image a second environment area, correlating with the first environment area, is determined. It is possible to define a search condition for the second environment area in such a way that the first environment area and the second environment area are congruent or have similar characteristics. The second image analysis pixel, which correlates with the first image analysis pixel, is determined within the second environment area.

Within the framework of the present invention the above-mentioned steps of the method may be carried out in any order. According to the invention, it is, for example, possible that a first image analysis pixel and a second image analysis pixel, correlating with said first image analysis pixel, are determined and that subsequently a first environment area around the first image analysis pixel and a second environment area around the second image analysis pixel are determined.

The method of the invention is not restricted to the tabular determination of image analysis pixels. The above-described steps make it possible to select image analysis pixels according to other methods known to those skilled in the art, for example depending on changes of pixels taking place in the case of films.

The method of the invention may, among other things, be characterized in that, depending on image information elements, such as grey tints, colour tints, and structures, of the first original image and/or the second original image, characteristics, such as size, are assigned to the first environment area. Accordingly, the method of the invention may also comprise the assignment of characteristics, depending on image information elements, such as grey tints, colour tints, and structures, of the first original image and/or second original image, to the second environment area.

The structure of an image refers to a characteristic within the image, such as a tree or a corner of a house displayed in the image. In the same way, grey tints and colour tints may constitute image information elements.

Characteristics are assigned to the environment areas based on the image information elements. This may mean that an environment area extends, for example, over an area with different structures (for example, several trees of a forest), or that the limits of the environment areas are determined by the image information.

The characteristics may, for example, be assigned in such a way that a specific characteristic, such as size, is assigned to the environment area depending on colour intensity distributions or a contrast gradient.

The method of the invention may be complemented by assigning characteristics to the first environment area, said characteristics depending on the characteristics of at least one adjacent environment area of the first original image and/or on characteristics of at least one environment area which is adjacent to the environment area surrounding the correlating image analysis pixel. Accordingly, it is also possible that characteristics depending on the characteristics of at least one adjacent environment area of the second original image and/or on characteristics of at least one environment area which is adjacent to the environment area surrounding the correlating image analysis pixel are assigned to the second environment area.

The above-mentioned exemplary dependencies are created to make sure that the method of the invention does not generate too great differences with view to the structure or other determining elements of the pseudo holographic image, which may be perceived as disturbing by the viewer.

Within the scope of the discussion, it is not excluded that the environment area which above is designated as “adjacent” overlaps with parts of the relevant first or second environment area.

The method of the invention may comprise the determination of parameters for the generation of a pixel of the pseudo holographic image from the first pixel and/or the second pixel, said determination being based on the characteristics assigned to the first environment area and/or the characteristics assigned to the second environment area.

The method of the invention may be characterised in that, in the course of an adaptive process by which the quality of the pseudo holographic image is optimised, characteristics are assigned to the first environment area and/or the second environment area.

Said adaptive process includes all the methods known to those skilled in the art for a result-based assessment of the executed steps of the method. Preferably, self-learning routines are used in this connection in order to improve the quality of the final result of the individual steps of the pseudo holographic method.

The method of the invention may comprise routines resulting in the first environment area comprising at least one first pixel of the first original image and/or the second environment area comprising at least one second pixel of the second original image.

If an environment area extends, for example, over a region of the first original image or the second original image, whereby said region comprises pixels of the same or similar contents, it may be reasonable to combine those pixels to form one environment area around an image analysis pixel. Thus, characteristics which correspond to those of the relevant image analysis pixel or which have been changed in order to correspond to those of the relevant image analysis pixel are assigned to the pixels.

In the framework of the method of the invention, it is also possible that an environment area only comprises the relevant image analysis pixel and no further relevant pixels.

The method of the invention may, in view of the fact that an environment area may comprise at least one pixel, comprise steps for selecting the image analysis pixels, whereby the selection of the first image analysis pixel and/or the second image analysis pixel is carried out depending on the characteristics of the first environment area. Accordingly, it is also possible that the selection of the first image analysis pixel and/or the second image analysis pixel is carried out depending on the characteristics of the second environment area.

If the further first or second image analysis pixel selected from the relevant pixels lies outside the first or second environment area, respectively, it is not excluded, within the framework of the present invention, that the further environment area overlaps, at least partially, with the first or second environment area, respectively.

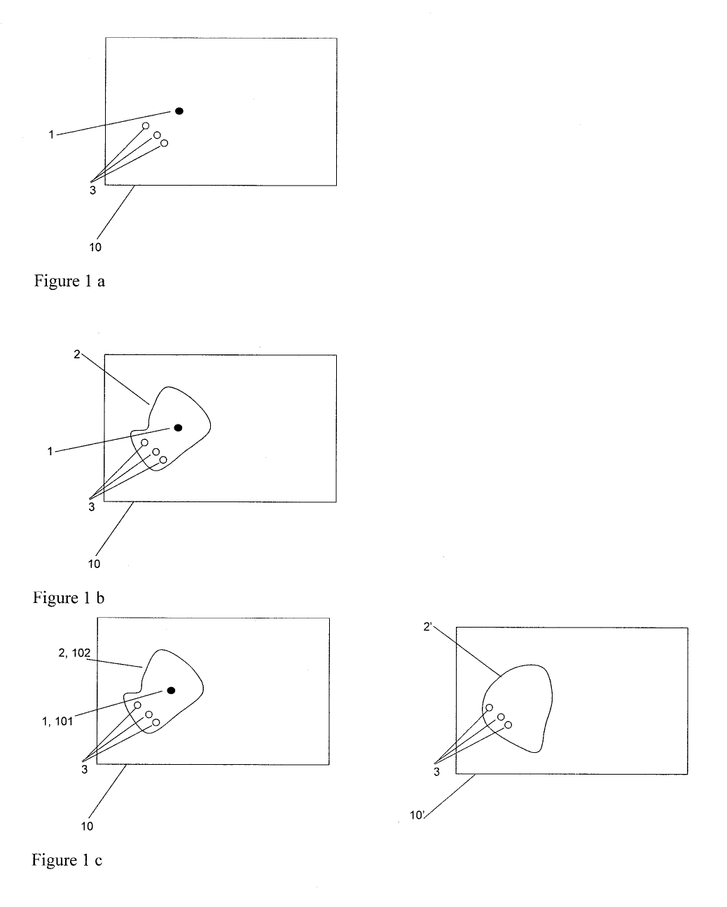

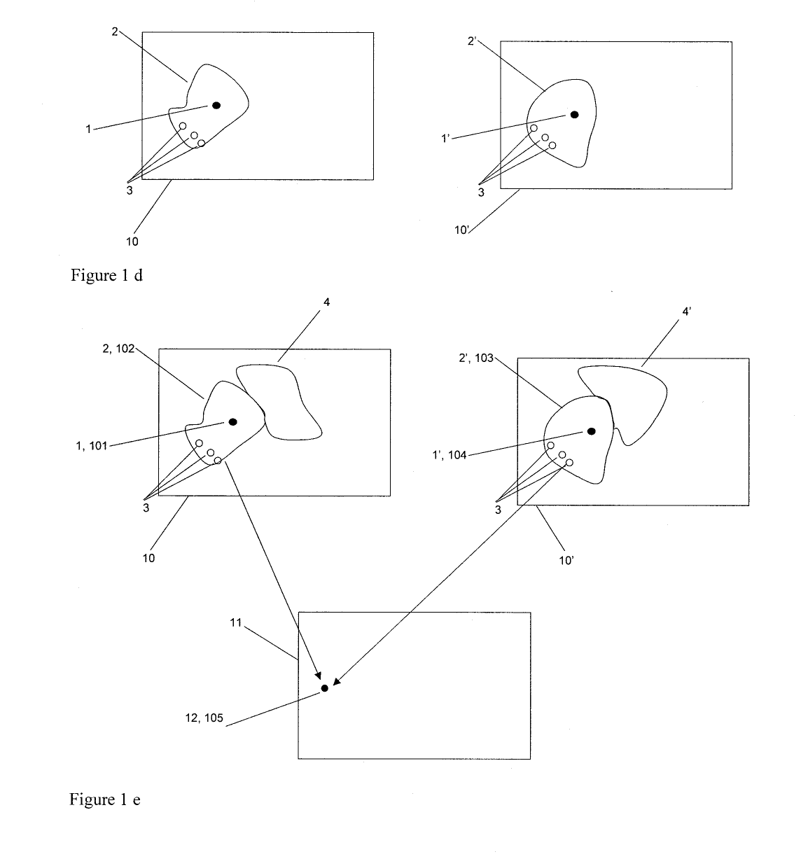

FIGS. 1a-1e are a schematic view of an embodiment of the method of the present invention, each of the FIGS. 1a to 1e showing one of the steps I to V individually.

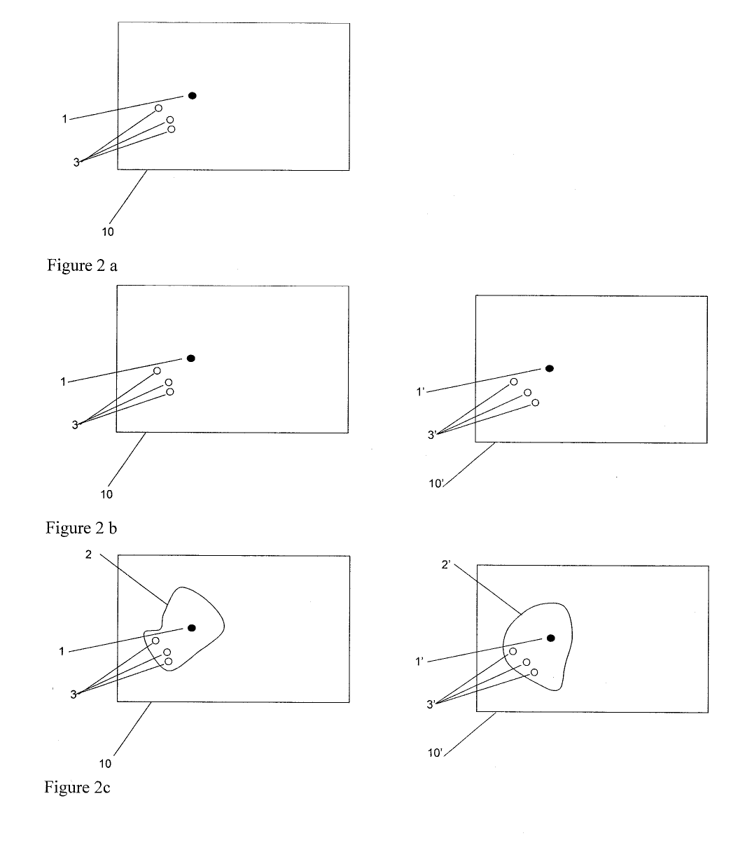

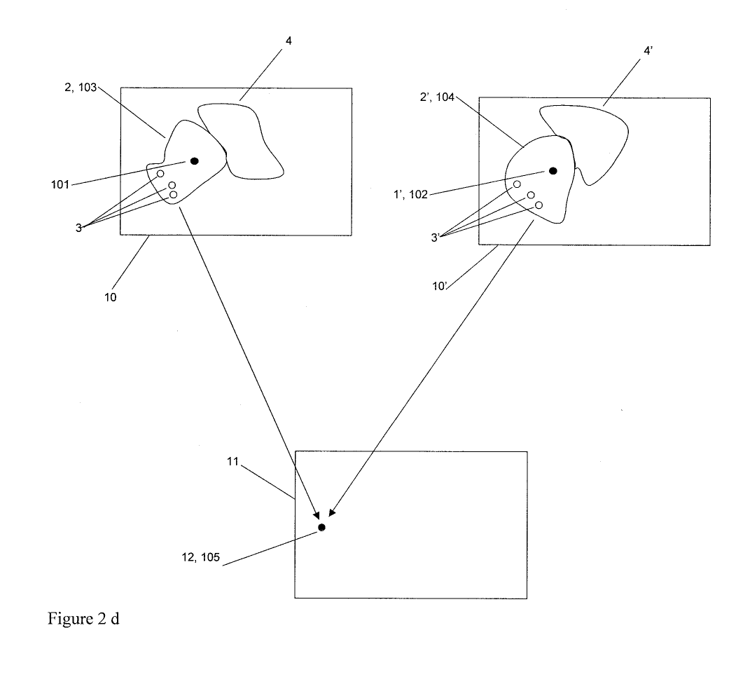

FIGS. 2a-2d show another embodiment of the method of the present invention, each of the FIGS. 2a to 2d showing one of the steps I to IV individually.

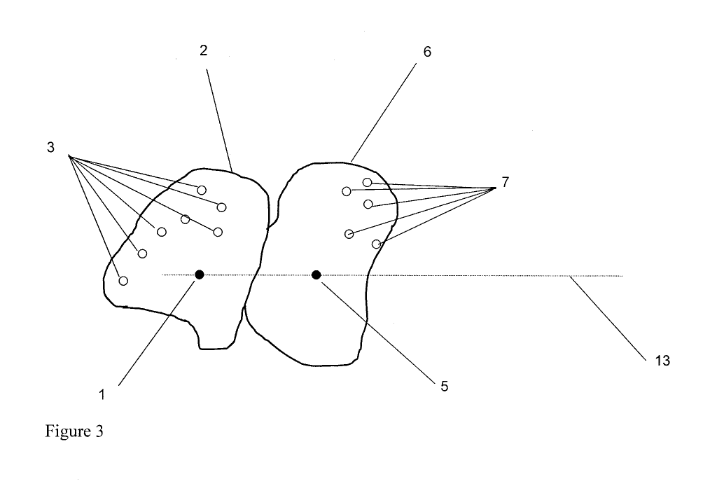

FIG. 3 illustrates a process for selecting image analysis pixels within the framework of the method of the present invention.

FIG. 1 is a schematic view of an embodiment of the method of the present invention for generating a pseudo holographic image 11 from a first original image 10 comprising a plurality of first pixels 3 and a second original image 10′ comprising a plurality of second pixels 3′, whereby in step I, according to the prior art, first image analysis pixels 1 are selected from the plurality of first pixels 3 in a predetermined order. In step II, a first variable, adaptive environment area 2 is created according to the invention in the first original image 10 around a first analysis pixel 1; in step III a second environment area is searched for in the second original image 10′, said second environment area 2′ correlating with the first environment area 2; in step IV a second image analysis pixel 1′ in the second environment area 2′ is determined, said second image analysis pixel 1′ correlating with the first image analysis pixel 1. In step V, depending on image information elements, such as grey tints, colour tints, and structures, of the first original image 10 and/or the second original image 10′, characteristics, such as size, are assigned to the first environment area 2 and/or the second environment area 2′. The assignment of the characteristics of the first environment area 2 and/or the second environment area 2′ further depends on the relevant adjacent environment areas 4, 4′.

In step V, parameters for the generation of the pixel 12 of the pseudo holographic image 11 are determined based on the characteristics assigned to the first environment area 2 and/or the second environment area 2′. In another step, based on the quality of the pseudo holographic image 13, new characteristics may be assigned to the first environment area 2 and the second environment area 2′.

The first environment area 2 and/or the second environment area 2′ may comprise a pixel 3, 3′ of the corresponding original image 10, 10′.

FIG. 2 shows a schematic view of an embodiment of the method of the invention for generating a pseudo holographic image 11 from a first original image 10 comprising a plurality of first pixels 3 and a second original image 10′ comprising a plurality of second pixels 3′, whereby in step I, according to the prior art, first image analysis pixels 1 are selected from the plurality of first pixels 3 in a predetermined order. In step II, a second image analysis pixel 1′ in the second environment area 2′ is determined, said second image analysis pixel 1′ correlating with the first image analysis pixel 1; in step II, a first variable, adaptive environment area 2 is determined in the first original image 10 around a first analysis pixel 1; in step III, a second environment area 2′ is created in the second original image 10′, said second environment area 2′ correlating with the first environment area 2. In step IV, depending on image information elements, such as grey tints, colour tints, and structures, of the first original image 10 and/or the second original image 10′, characteristics, such as size, are assigned to the first environment area 2 and/or the second environment area 2′. The assignment of the characteristics of the first environment area 2 and/or the second environment area 2′ further depends on the relevant adjacent environment areas 4, 4′. Based on the characteristics assigned to the relevant environment areas, parameters for the generation of the pixel 12 of the pseudo holographic image 11 are determined, and the pixel 12 is generated. Another step may comprise the assignment of new characteristics to the first environment area 2 and the second environment area 2′ based on the quality of the pseudo holographic image 13.

The first environment area 2 and/or the second environment area 2′ may comprise at least one pixel 3, 3′ of the corresponding original image 10, 10′.

FIG. 3 illustrates a process for selecting image analysis pixels in the framework of the method of the present invention, whereby the image analysis pixels 1, 5 are selected along the line 13, which constitutes an example of the order of the selection of the image analysis pixels 1, 5.

After the selection of the first image analysis pixel 1, a first environment area 2, which comprises first pixels 3, is formed. The selection of another first image analysis pixel 5 is determined by the pixel's position on the line 13, whereby said other first image analysis pixel 5 lies outside the first environment area 2, as well as by the described creation of another first environment area 6. The further first environment area 6 comprises further first pixels 7.

1. A method for generating a pseudo holographic image (11) from a first original image (10) comprising a plurality of first pixels (3) and a second original image (10′) comprising a plurality of second pixels (3′), whereby first image analysis pixels (1) are selected from said plurality of first pixels (3) in a predetermined order, characterised in that the method of the invention comprises the following steps for each selected image analysis pixel:
creating a first variable, adaptive environment area (2) in the first original image (10) around a first analysis pixel (1),
searching for a second environment area in the second original image (10′), said second environment area (2′) correlating with the first environment area (2),
determining a second image analysis pixel (1′) in the second environment area (2′), said second image analysis pixel (1′) correlating with the first image analysis pixel (1).

2. The method according to claim 1, characterised in that, depending on image information elements, such as grey tints, colour tints, and structures, of the first original image (10) and/or the second original image (10′), characteristics, such as size, are assigned to the first environment area (2).

3. The method according to claim 1 or claim 2, characterised in that, depending on image information elements, such as grey tints, colour tints, and structures, of the first original image (10) and/or the second original image (10′), characteristics are assigned to the second environment area (2′).

4. The method according to any one of the claims 1 to 3, characterised in that characteristics are assigned to the first environment area (2) depending on characteristics of at least one adjacent environment area (4) of the first original image (10) and/or on characteristics of at least one environment area (4′) which is adjacent to the environment area (2′) which surrounds the correlating image analysis pixel (1′).

5. The method according to any one of the claims 1 to 4, characterised in that characteristics are assigned to the second environment area (2′) depending on characteristics of at least one adjacent environment area (4′) of the second original image (10′) and/or on characteristics of at least one environment area (4) which is adjacent to the environment area (2) which surrounds the correlating image analysis pixel (1).

6. The method according to any one of the claims 1 to 5, characterised in that, based on the characteristics assigned to the first environment area (2) and/or on the characteristics assigned to the second environment area (2′), parameters for the generation of a pixel (12) of the pseudo holographic image (11) from the first pixel and/or the second pixel (1′) are determined.

7. The method according to any one of the claims 1 to 6, characterised in that characteristics are assigned to the first environment area (2) and/or the second environment area (2′) in the course of an adaptive process by which the quality of the pseudo holographic image (11) is optimised.

8. The method according to any one of the claims 1 to 7, characterised in that the first environment area (10) comprises at least one first pixel (3) of the first original image (10) and/or in that the second environment area (10′) comprises at least one second pixel (3′) of the second original area (10′).

9. The method according to any one of the claims 1 to 7, characterised in that the first image analysis pixel (1) and/or the second image analysis pixel (1′) is/are selected depending on the characteristics of the first environment area (2).

10. The method according to any one of the claims 1 to 9, characterised in that the first image analysis pixel (1) and/or the second image analysis pixel (1′) is/are selected depending on the characteristics of the second environment area (2′).
